(19) United States
(12) Patent Application Publication
(10) Pub. No.: US 2005/0198053 A1
(43) Pub. Date: Sep. 8, 2005

(54) Recording medium having a data structure for managing text subtitles and recording and reproducing methods and apparatuses

(76) Inventors: Kang Soo Seo, Anyang-si (KR); Byung Jin Kim, Seongnam-si (KR); Jea Yong Yoo, Seoul (KR)

Correspondence Address: HARNESS, DICKEY & PIERCE, P.L.C., P.O. BOX 8910, RESTON, VA, 20195, US

(21) Appl. No.: 11/022,759

(22) Filed: Dec. 28, 2004

Related U.S. Application Data
(60) Provisional application No. 60/542,852, filed on Feb. 10, 2004.
(60) Provisional application No. 60/542,850, filed on Feb. 10, 2004.
(60) Provisional application No. 60/543,328, filed on Feb. 11, 2004.

(30) Foreign Application Priority Data
Feb. 26, 2004 (KR) 10-2004-0013098

(51) Int. Cl. G06F 17/00

(52) U.S. Cl. 707/100

(57) ABSTRACT

In the data structure for managing text subtitles, a dialog presentation segment includes text subtitle data of each text subtitle for presentation during a presentation time slot. The dialog presentation segment provides a presentation time stamp start time and a presentation time stamp end time defining the presentation time slot such that the presentation time slot does not overlap a presentation time slot of another dialog presentation segment.

### CROSS-REFERENCE TO RELATED APPLICATIONS

This application claims the benefit of priority under 35 U.S.C. 119 on Korean Application No. 10-2004-0013098, filed on Feb. 26, 2004, which is hereby incorporated by reference in its entirety.

### BACKGROUND OF THE INVENTION

1. Field of the Invention

The present invention relates to high density recording media such as read-only blu-ray discs (BD-ROM).

2. Discussion of Related Art

Optical discs are widely used as an optical recording medium. Presently, of the optical discs, a new high density optical recording medium (HD-DVD), such as the Blu-ray Disc (hereafter called “BD”), for recording and storing a large amount of high definition video and audio data is under development.

Currently, global standard technical specifications of the Blu-ray Disc (BD), a next generation HD-DVD technology, are being established as a next generation optical recording solution that can store amounts of data significantly surpassing present DVDs.

In relation to this, development of optical reproducing apparatuses for the Blu-ray Disc (BD) standards has also started. However, the Blu-ray Disc (BD) standards are not complete yet, and there has been difficulty in developing a complete optical reproducing apparatus.

Particularly, for effective reproduction of data from the Blu-ray Disc (BD), in addition to main AV data, various kinds of other data may be reproduced for the convenience of a user, such as supplementary or supplemental data (e.g., interactive graphics data, subtitle data, etc.) related to the main AV data. Accordingly, managing information should be provided for managing reproduction of the main data and the supplemental data. However, in the present Blu-ray Disc (BD) standards, because consolidated standards for managing the various data, particularly the supplemental data are not complete yet, there are many restrictions on the development of a Blu-ray Disc (BD) optical reproducing apparatus.

### SUMMARY OF THE INVENTION

A recording medium according to the present invention includes a data structure for managing reproduction of text subtitles.

In one embodiment, the recording medium stores a dialog presentation segment that includes text subtitle data of each text subtitle for presentation during a presentation time slot. The dialog presentation segment provides a presentation time stamp start time and a presentation time stamp end time defining the presentation time slot such that the presentation time slot does not overlap a presentation time slot of another dialog presentation segment.

In an embodiment, the dialog presentation segment defines a number of regions, and each region provides text subtitle data. The text subtitle data may be one of text string data and style data.

In another embodiment, the dialog presentation segment references a region style for each region, and the referenced region style defines a position and a size of the region.

In a further embodiment, the dialog presentation segment includes continuous presentation information for each region indicating whether the region is to be continuously reproduced from a previous dialog presentation segment. In this embodiment, the presentation time stamp start time of the dialog presentation segment equals a dialog presentation time stamp end time of the previous dialog presentation segment when the continuous presentation information of a region in the dialog presentation segment indicates continuous reproduction.

In another embodiment, the recording medium stores a text subtitle stream. The text subtitle stream includes a dialog style segment followed by one or more dialog presentation segments. The dialog style segment defines one or more styles. Each dialog presentation segment includes text subtitle data of each text subtitle for presentation during a presentation time slot, and each dialog presentation segment references at least one of the styles in the dialog style segment.

The present invention further provides apparatuses and methods for recording and reproducing the data structure according to the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention.

In the drawings;

FIG. 1 illustrates a file structure for managing various data on a disc in accordance with an example embodiment of the present invention.

FIG. 2 illustrates an example embodiment of a disc volume for a BD-ROM according to the present invention;

FIG. 3 is a diagram of a displayed image of a text subtitle stream on a display screen according to an embodiment of the present invention;

FIG. 4 graphically shows a data structure and method of reproducing/managing a text subtitle according to an embodiment of the present invention.

FIGS. 5A to 5C show text subtitle playback management information recorded within a text subtitle stream according to the present invention, in which dialog information, region information, and style information (Style Info) are explained, respectively.

FIG. 6A and FIG. 6B show a data structure and method of providing text subtitles using the dialog, region, and style information as text subtitle reproducing/managing information;

FIG. 7 is a diagram of a text subtitle stream file structure according to an embodiment of the present invention;

FIG. 8, FIGS. 9A-9C to FIGS. 10A-10C are diagrams of data structure syntaxes of a text subtitle stream according to embodiments of the present invention; and

FIG. 11 is a block diagram of an optical recording/reproducing apparatus according to an embodiment of the present invention.

### DETAILED DESCRIPTION OF THE EXEMPLARY EMBODIMENTS

Reference will now be made in detail to the embodiments of the present invention, examples of which are illustrated in the accompanying drawings. Wherever possible, the same reference numbers will be used throughout the drawings to refer to the same or like parts.

Though words used in the present invention are selected from widely used general words, there are words the applicant has selected at his discretion and the detailed meanings of these words are described in relevant parts of the description of the present invention. As such, the present invention is to be understood by meanings of the words provided in the disclosure.

Relating to terms associated with the present invention, ‘main data’ is information (e.g., title information) recorded in a recording medium (e.g., an optical disc) such as video and voice data provided to a user by an author. ‘Main data’ is generally recorded in the MPEG2 format, and may be called the ‘main AV stream’.

‘Auxiliary or supplemental data’ is the data associated with ‘main data’ and provided to a user for convenience of playing back the ‘main data’. For example the supplemental data includes subtitle information, interactive graphic stream, presentation graphic stream, sound information, auxiliary audio data for a browsable slide show, etc. In accordance with the features of the respective auxiliary data, ‘auxiliary data’ may be recorded in the MPEG2 format and multiplexed with the main AV stream, or may be recorded in a stream file independent from the main AV stream and in the MPEG2 format or other format.

‘Subtitle’ as the auxiliary data is a kind of caption information. ‘Subtitle’ means information displayed on one side of a screen if a user, who intends to view a currently played video (main AV data) with a caption in specific language, selects one of the subtitles supported by the recording medium for the specific language. Hence, a ‘subtitle’ may be provided in various ways. Specifically, a ‘subtitle’ recorded as text data is called a ‘text subtitle’.

In the following example embodiments of the present invention, the ‘text subtitle’ is configured in the MPEG2 format and is recorded as a stream file independent from ‘main data’, for example.

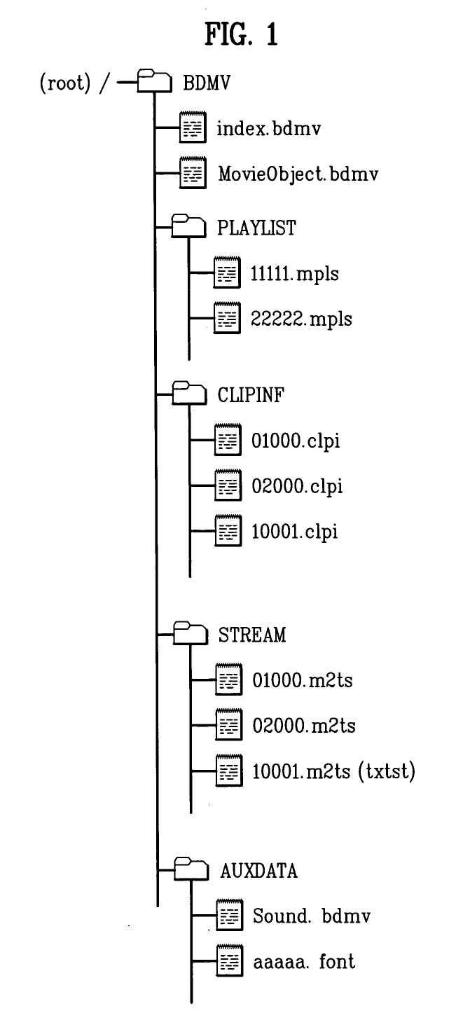

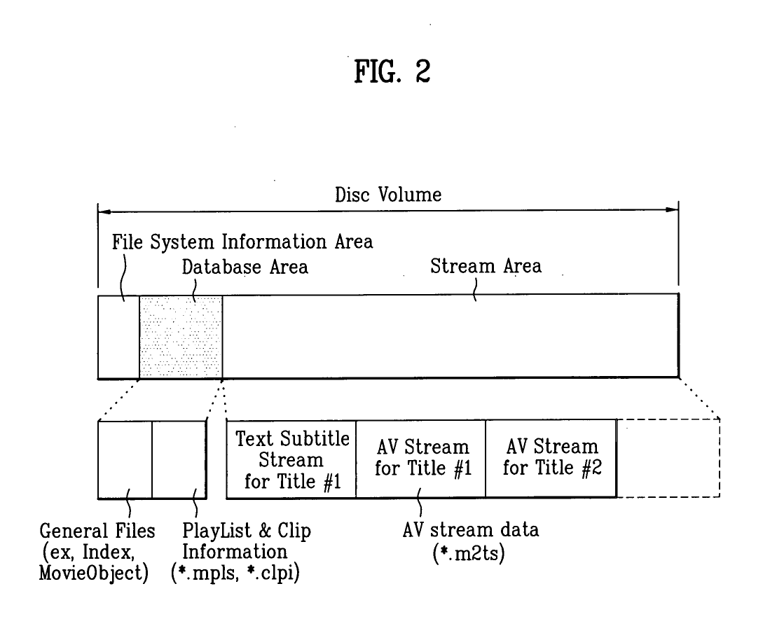

A format for recording main data and supplementary data on the recording medium such as a BD disc, and a file structure for managing the data will be described in detail with reference to FIGS. 1 and 2.

FIG. 1 illustrates a file structure for managing various data on a disc in accordance with an example embodiment of the present invention. As shown, at least one BD directory BDMV exists beneath one root directory. In the BD directory BDMV, an index file index.bdmv and an object file MovieObject.bdmv are included as general file (upper file) information to secure interactivity with a user. Moreover, a playlist directory PLAYLIST, clipinfo directory CLIPINF, stream directory STREAM, and auxiliary data directory AUXDATA are included in the BD directory BMDV.

Files for video and audio streams, which are called ‘main AV stream’, recorded in a disc according to specific formats and auxiliary stream such as text subtitle (hereinafter called text subtitle stream) independently exist in the stream directory STREAM. Because the text subtitle streams files and AV stream files are recorded in the MPEG2 format (e.g., MPEG2 transport packets), ‘*.m2ts’ is used the extension name of each stream file (e.g., 01000.m2ts, 02000.m2ts, and 10001.m2ts). Alternatively, in case of the text subtitle stream file, ‘*.txtst’ may be used as the file extension name since the text subtitle stream has auxiliary data features different from that of the main AV stream, for example.

In the BD specifications, the AV stream may be called a clip stream file. Relating to the present invention, the text subtitle data will exist in the form of a separate file from the AV stream file. For example in FIG. 1, the text subtitle data exists as the text subtitle stream file 10001.m2ts or 10001.txtst.

The clipinfo (or clip information) directory CLIPINF includes clip information or clipinfo files *.clpi, each having a one-to-one correspondence with a stream file. A clipinfo file *.clpi has attribute information and timing information of the corresponding stream file and serves as a management file. More specifically, the information in the clipinfo file includes mapping information that enables mapping of a Presentation Time Stamp (PTS) to a Source Packet Number (SPN) of a source packet in the corresponding stream file. This map is referred to as an Entry Point Map or “EP_map”.

A stream file and the corresponding clipinfo file may be called a “clip”, collectively. Accordingly, the file “01000.clpi” in the clipinfo directory CLIPINF has attribute information and timing information on the file “01000.m2ts” in the stream directory STREAM, and the files “01000.clpi” and ‘01000.m2ts” form a clip.

The playlist directory PLAYLIST includes playlist files *.mpls, each having at least one playitem PlayItem designating a playing interval of a particular clip. The playitem PlayItem includes timing information on a play start time In-Time and play end time Out-Time of a particular clip for playback, and identifies the clip by providing the clip information file name in a Clip_Information_File _name field. Using the PTS information in the In-Time and Out-time information, the EP map of the named clipinfo file allows a particular stream address or position (e.g., SPN) of the corresponding stream file to be searched for and obtained such that reproduction of the playitem results in reproduction of the clip.

The playlist file *.mpls serves as a basic management file for playing a desired clip by providing at least one playitem PlayItem. Moreover, the playlist file *.mpls may also provide a sub-playitem SubPlayItem for managing reproduction of, for example, supplemental data, which may be reproduced synchronized or non-synchronized with the playitem PlayItem. For instance, in case of including SubPlayItem for playing back text subtitle, the corresponding SubPlayItem is synchronized with the PlayItem to play back the data. Yet, in case of including SubPlayItem for playing back audio data for a browsable slide show, the corresponding SubPlayItem is non-synchronized with PlayItem.

In the present invention, auxiliary data including text subtitles is managed by SubPlayItems for example, which will be explained in detail below.

The auxiliary data directory AUXDATA is an area for separately recording auxiliary data files for the playback. For instance, in order to support more user-friendly playback, a sound file Sound.bmdv for providing a click sound, a font file *.font or *.otf employed with text subtitle playback, and the like are recorded therein.

Accordingly, the text subtitle stream 10001.m2ts, which is a kind of auxiliary data, may be recording in the auxiliary data directory AUXDATA.

Moreover, in the above-explained BD directory BDMV, the index file index.bdmv and the object file MovieObject.bdmv exist as general files to secure interactivity with a user. The index file index.bdmv has an index table providing menu information and title information the user can select. The MovieObject.bdmv provides navigation commands for, for example, executing a playlist, and may be called from a selection made in the index table.

As shown in FIG. 2, the disc volume of a BD-ROM is organized into a File System Information Area, a Database Area, and a Stream Area. The File System Information Area stores system information for managing the disc. The Database Area includes a general files area and a playlist and clip information area. The general files area stores general files such as the index.bdmv file and the MovieObject.bdmv file. The playlist and clip information area stores the PLAYLIST directory and the CLIPINF directory. The main data and the supplemental data (STREAM and AUXDATA directories) are recorded in the Stream Area. According to this, a reproducing apparatus determines the main data and the supplementary data desired to reproduce, by using file information in the Database Area and/or stream management information in the Stream Area.

Hence, via the file information within the database area and/or the stream management information within the stream file area (Stream Area), a user decides the main and auxiliary data to be reproduced and their reproducing method.

In the following description, management information data structures for managing reproduction of text subtitles will be described, and methods of recording and reproducing the management information and text subtitles using the recorded management information will be explained.

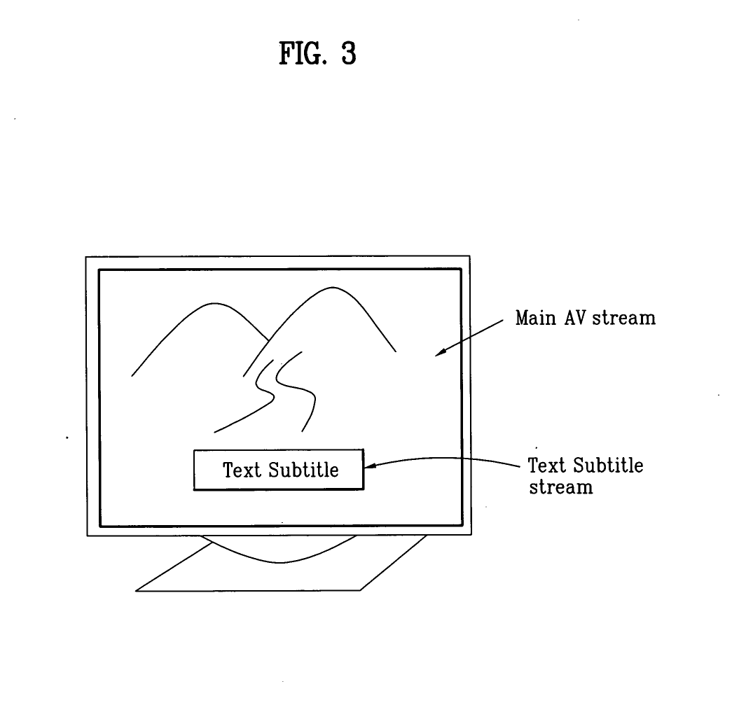

FIG. 3 shows that text subtitle data and main data are simultaneously displayed an a display screen according to an embodiment of the present invention, in which the text subtitle is synchronized in time with the main data.

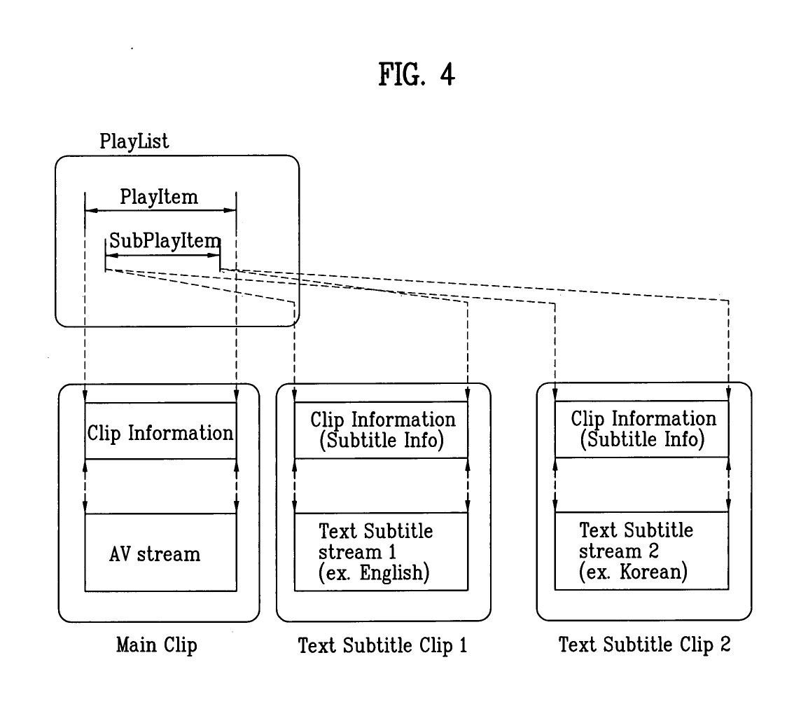

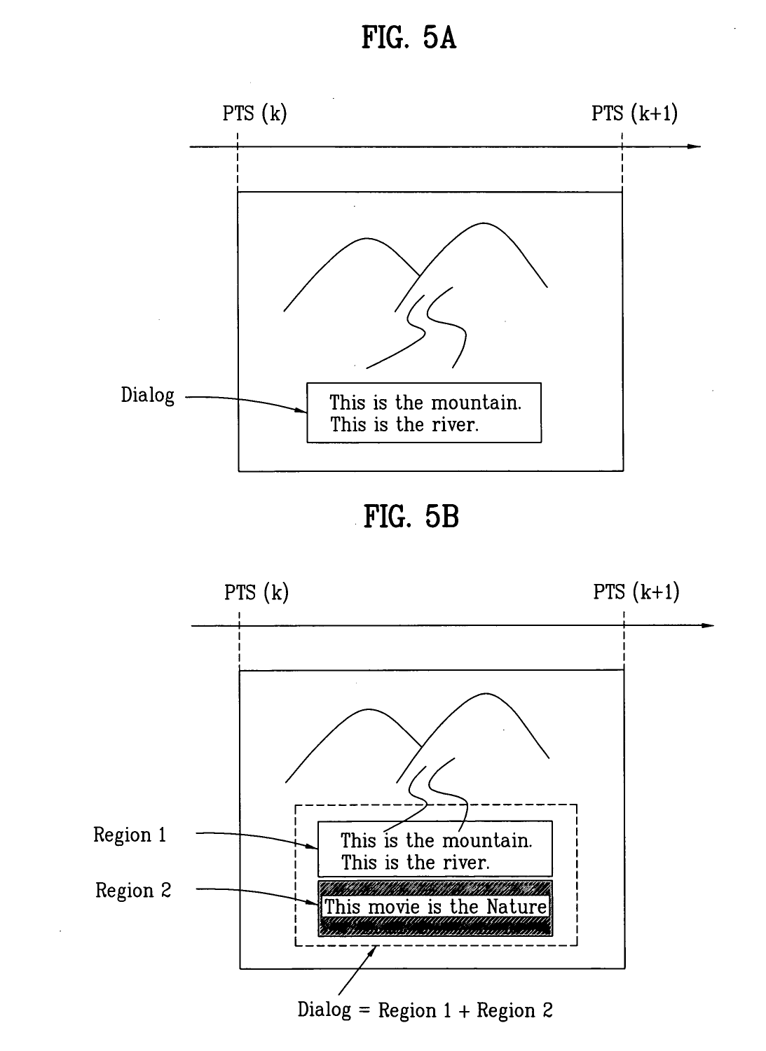

FIG. 4 graphically shows a data structure and method of reproducing/managing a text subtitle according to an embodiment of the present invention. As shown, at least one PlayItem for reproducing/managing a main AV clip exists within a PlayList file. When a text subtitle associated with the main AV data exists, the text subtitle is managed by a SubPlayItem. More specifically, a single SubPlayItem manages a plurality of text subtitle clips. Accordingly, the SubPlayItem provides the a single, same play interval (e.g., In-Time and Out-Time) for each clip.

For instance, a text subtitle clip 1 in English and a text subtitle clip 2 in Korean separately exist. The respective text subtitle clip 1 and clip 2 are synchronized with the main AV data in time, and will be displayed on a screen together with the main AV data at a demanded presentation time.

Hence, in order to reproduce the text subtitle, information including playback presentation time, position and size on the screen is provided as management information. A data structure and method of recording various kinds of management information for reproducing the text subtitle as file information within a recording medium are explained in detail below.

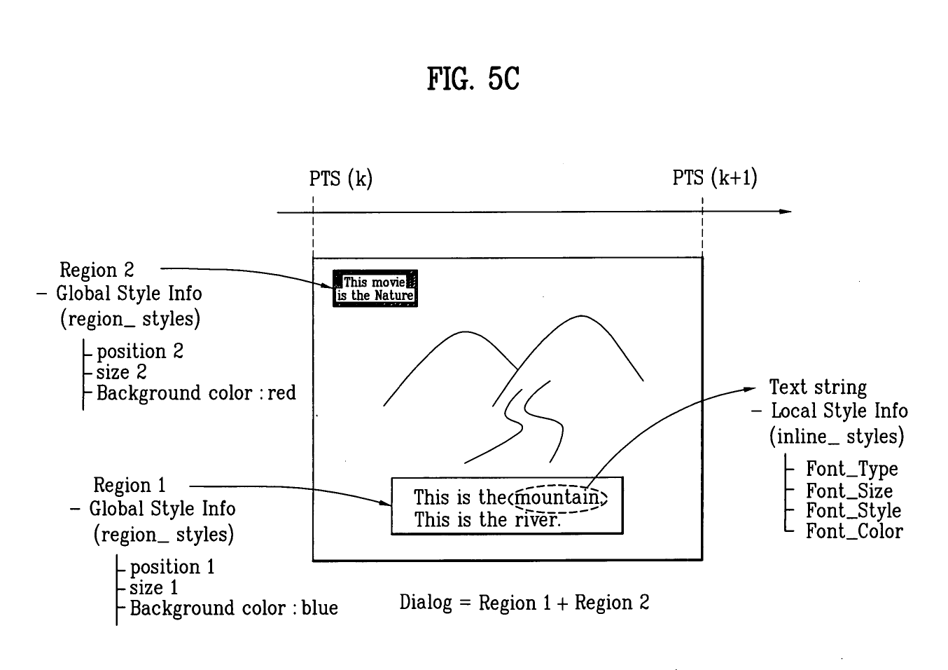

FIGS. 5A to 5C show text subtitle playback management information recorded within a text subtitle stream according to the present invention, in which dialog information, region information, and style information (Style Info) are explained, respectively.

FIG. 5A shows dialog information (Dialog) as information for reproducing/managing a text subtitle of the present invention, in which ‘Dialog’ means the management information for managing at least one text subtitle data existing within a specific presentation time.

Namely, a presentation time for informing a play time on a screen is generally managed using ‘PTS (presentation time stamp)’ and the entire text subtitle displayed during a specific PTS interval or slot is defined as a ‘Dialog’, thereby enhancing the convenience for the reproducing/management.

For instance, text subtitle data displayed during a time between PTS(k) and PTS(k+1) is constructed with two lines, whereby it can be seen that the entire text subtitle data is defined by the same Dialog. And, it is sufficient that the condition for the line number of the text subtitle data included in the Dialog is at least one line.

FIG. 5B shows managing text subtitles as regions, in which ‘region’ means a region to which style information (Style Info, specifically, ‘global style information’) explained in detail below is applied to the text subtitle in the region for the presentation time of the Dialog. In one embodiment, a maximum of two regions may be enabled to exist within one Dialog. Namely, a Dialog may manage one region or two regions. And, the line number of the text subtitle data included per region may be defined as at least one line.

In this embodiment of the present invention, a maximum of two regions may be enabled within one Dialog, which takes the decoding load on playing back text subtitles into consideration. However, a maximum of n regions where n≧2 may be defined to exist within one Dialog in alternative implementations.

FIG. 5C shows style information (Style Info) as information for playback management of a text subtitle according to an embodiment of the present invention. The ‘style information (Style Info)’ is information for designating a method of displaying text subtitle data on a screen. For example, the style information (Style Info) includes position on the screen, size, background color, and the like. Additionally, various kinds of information such as text alignment, text flow, and the like may be provided as the style information (Style Info). A detailed explanation of this style information (Style Info) will be explained with respect to FIGS. 9A to 10C below.

As further shown, the style information (Style Info) may be divided into ‘global style information (Global Style Info)’ and ‘local style information (Local Style Info)’. This enables greater flexibility in the display of text subtitle data. The ‘global style information (Global Style Info)’ is the style information (Style Info) applied to the entire associated region such as the position, size, and the like. This global style information may also be called ‘region style information (region_styles)’. FIG. 5C shows an example that two regions (region #1 and region #2) have different ‘region style information (region_styles)’, respectively. Region 1 (region #1) has the region style information region_styles of ‘position1, size1, color=blue’, whereas region 2 (region #2) has the region style information region_styles of ‘position2, size2, color=red’. The ‘region style information (region_styles)’ will be explained in detail with respect to FIG. 9B.

The ‘local style information (Local Style Info)’ is style information (Style Info) applied per data line or text data character within a region, and may also be called ‘inline style information (inline_styles)’. For instance, FIG. 5C shows an example that the inline style information (inline_styles) is applied within region #1, in which inline style information (inline_styles) different from other text is applied to a ‘mountain’ portion of text data. The inline style information (inline_styles) will be explained in detail with respect to FIG. 10C.

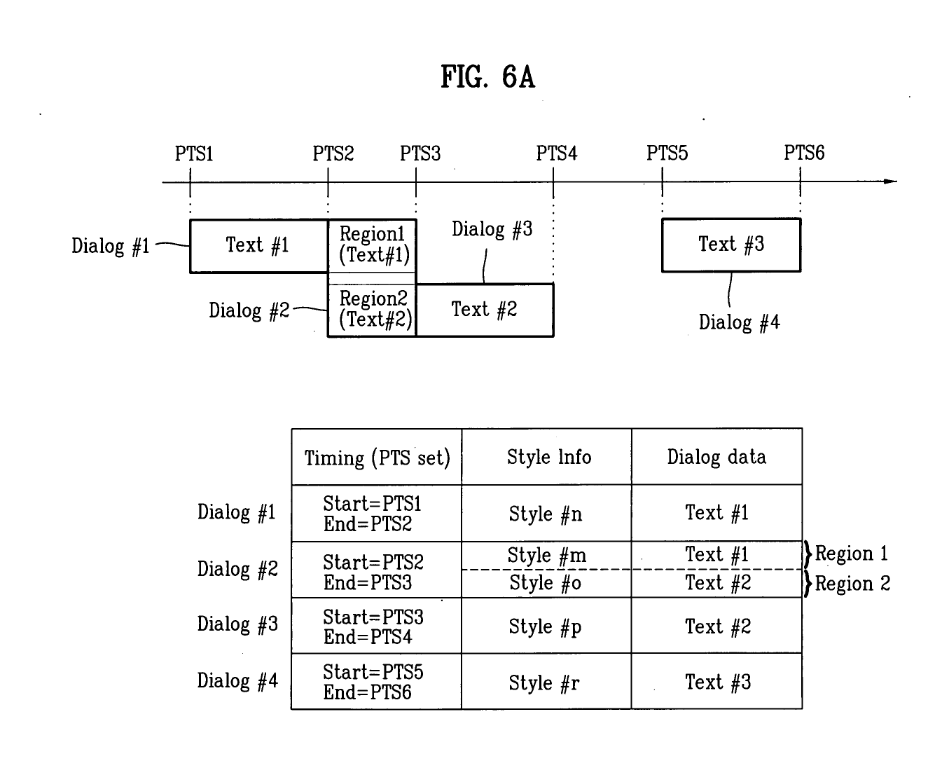

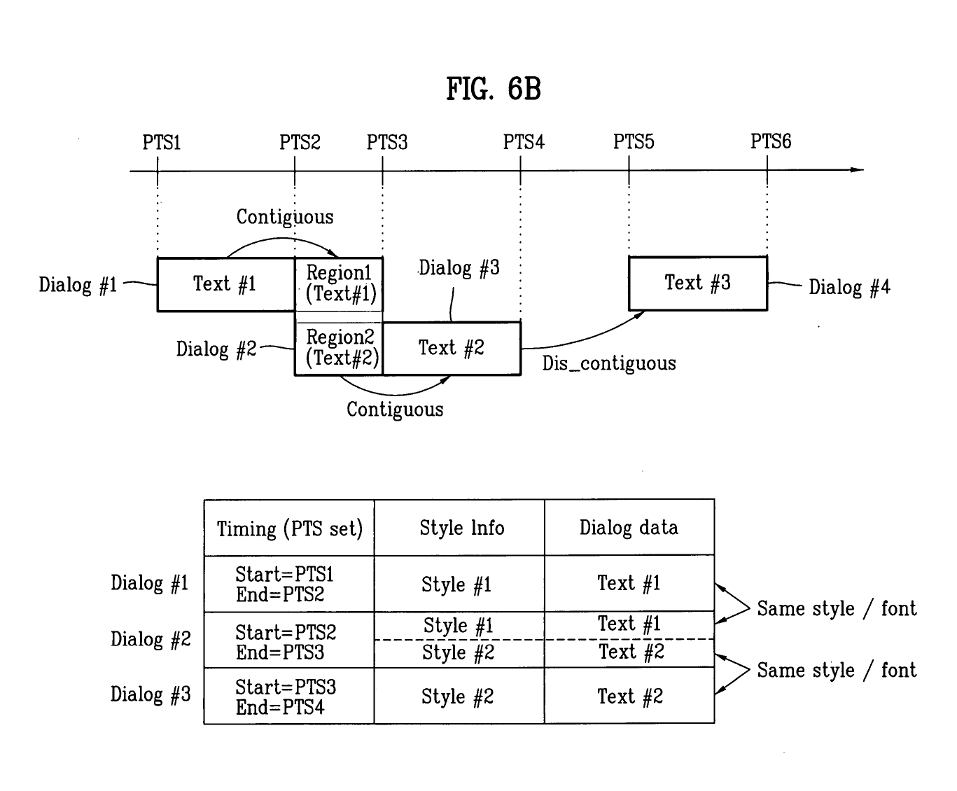

FIG. 6A and FIG. 6B show data structures and methods of providing text subtitles using the dialog, region, and style information as text subtitle reproducing/managing information.

FIG. 6A shows a data structure and method for managing text subtitles in which each presentation time stamp (PTS) slot or interval is managed by a Dialog. As shown, a Dialog #1 is displayed between PTS1˜PTS2. The Dialog #1 includes a single region text subtitle ‘Text #1’ as text data. Dialog #2 is displayed between PTS2˜PTS3, and has two regions Region 1 and Region 2 of text subtitle data ‘Text #1’ and ‘Text #2’, respectively. Accordingly, ‘Text #1’ in Region 1 and ‘Text #2’ in Region 2 are displayed as text data during the presentation time stamp interval PTS2˜PTS3. Dialog #3 is displayed between PTS3˜PTS4, and includes ‘Text #2’ as text data. Dialog #4 is displayed between PTS5˜PTS6 and includes ‘Text#3’ as text data. There exists no text subtitle data between PTS4˜PTS5.

As will be appreciated from FIG. 6A, the Dialogs do not overlap. Stated another way, the presentation time stamp slots for each respective Dialog do not overlap in this embodiment.

The above method of defining each dialog information is explained in more detail as follows. First of all, each Dialog provides time information (PFS set) for displaying the corresponding dialog, style information (Style Info), and information for real text data (called ‘Dialog Data’).

The time information (PTS set) is recorded as ‘PTS start’ information and ‘PTS end’ information in the Dialog data structure discussed in more detail below. For example, the PTS start information for Dialog #1 is PTS #1 and the PTS end information for Dialog #1 is PTS #2.

The style information (Style Info) includes ‘global style information (Global Style Info)’ and ‘local style information (Local Style Info)’ recorded as ‘region style information (region_styles)’ and ‘inline style information (inline_styles)’, respectively, in the Dialog data structure as discussed in detail below. The text data that is actually displayed is recorded as the ‘Dialog Data’ in the Dialog data structure.

Returning to FIG. 6A, because Dialog #2 includes two regions region 1 and region 2, style information (Style Info) and Dialog Data are respectively recorded in association with each of the regions region 1 and region 2. Namely, the style information for the two regions may be independent of one another and may be independent of other Dialogs.

FIG. 6B shows a data structure and method for continuous reproduction of text subtitles between two neighbor dialogs. For instance, Dialog #1 and the first region region 1 of Dialog #2 are continuously reproduced, and the second region region 2 of Dialog #2 and Dialog #3 are continuously reproduced.

The example shown in FIG. 6B is the same as the example shown in FIG. 6A except that 1) Text #1 is continuously reproduced by Dialog #1 and Dialog #2 and Text #2 is continuously reproduced by Dialog #2 and Dialog #3, 2) the style information for Text #1 in Dialog #1 and Dialog #2 is the same, and 3) the style information for Text #2 in Dialog #2 and Dialog #3 is the same.

For continuous reproduction, the PTS intervals of the Dialogs are continuous. As shown in FIG. 6B, while the Dialogs or their presentation time stamp intervals do not overlap, the end time of the first dialog in time and start time of the second dialog in time are the same. For example, PTS2 is the end time of Dialog #1 and the start time of Dialog #2, and PTS3 is the end time of Dialog #2 and the start time of Dialog #3. Also for continuous reproduction, the style information (Style Info) for the text subtitle continuous across dialogs should be identical. Accordingly, as shown in FIG. 6B, the style information for Text #1 in Dialog #1 and in region 1 of Dialog #2 is the same (i.e., Style #1), and the style information for Text #2 in region 2 of Dialog #2 and in Dialog #3 is the same (i.e., Style #2).

Furthermore, for continuous reproduction, flag information (continuous_present_flag) for indicating whether a dialog provides continuous playback from a previous dialog is included in the dialog data structure. Namely, the current dialog information includes a continuous present flag indicating whether this dialog requires continuous playback from the previous dialog. This data structure will be explained in more detail below with respect to FIG. 10A. Accordingly, in the example of FIG. 6B, the second and third Dialogs #2 and #3 include flag information indicating these dialogs require continuous playback from the previous dialog.

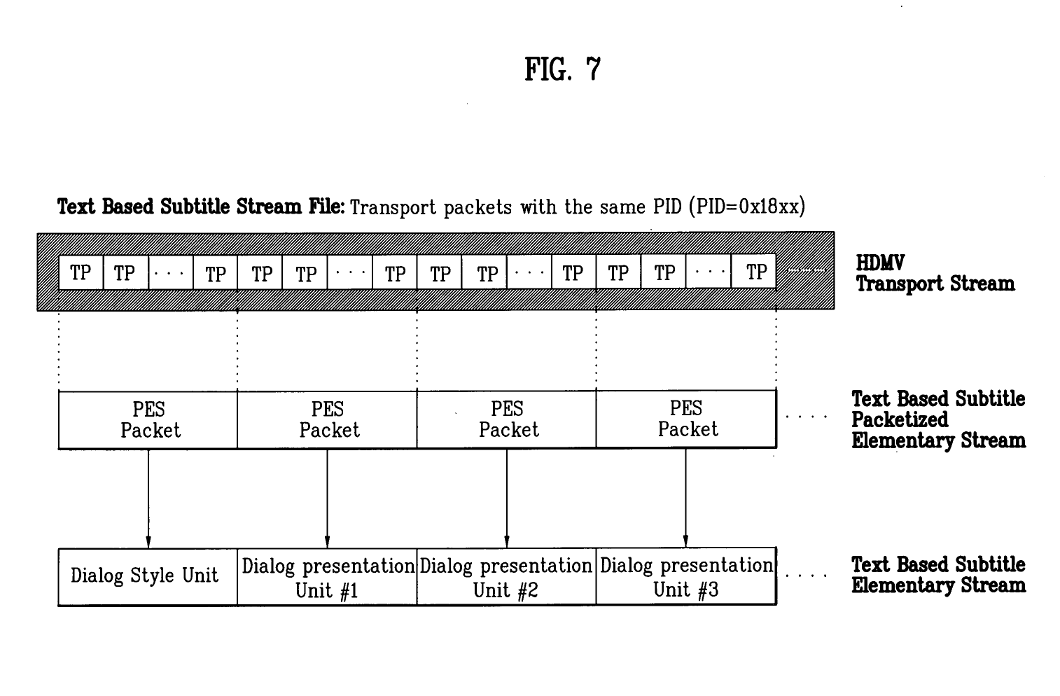

FIG. 7 shows a structure of a text subtitle stream file according to an embodiment of the present invention, in which a record form of the text subtitle stream file 10001.m2ts in FIG. 1 is illustrated for example.

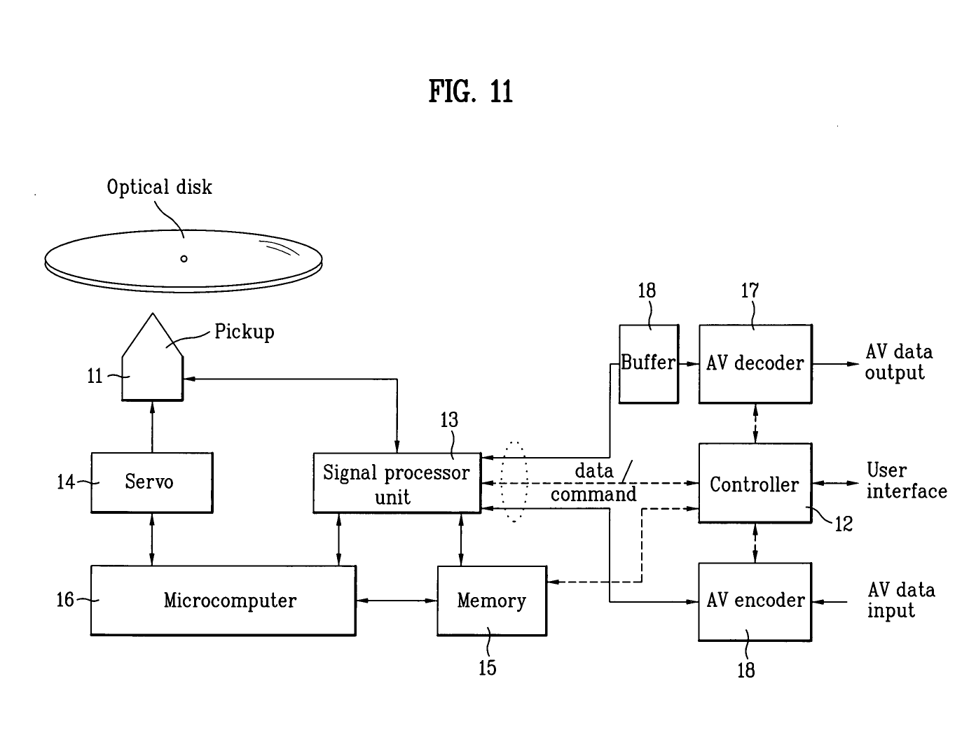

As shown, the text subtitle stream is configured into MPEG2 transport streams. The same packet identifier (PID), e.g., ‘PID=0x18xx’, is given to each transport packet TP forming the stream. Hence, an optical recording/reproducing apparatus (e.g., the apparatus of FIG. 11) reads out the transport packets having ‘PID=0x18xx’ from a stream to read out text subtitles, thereby facilitating the read out of only the text subtitle stream.

As further shown, a plurality of transport packets TPs from one packet elementary stream (PES) packet. In one embodiment of the present invention one ‘PES packet’ forms each dialog, thereby facilitating reproduction of the dialogs.

As still further shown, a ‘Dialog Style Unit (DSU)’ (or alternatively referred to as a Dialog Style Segment DSS) is recorded as a first ‘PES packet’ within the text subtitle stream. The DSU is the data structure for providing the style information (Style Info). The remaining PES packets are ‘Dialog Presentation Units (DPUs)’ (or alternatively referred to as Dialog Presentation Segments DPSs). A DPU is recorded as a unit of recording real dialog data therein. Hence, the DPUs may refer to the DSU for style information in reproducing the text subtitle data. Namely, in the text subtitle stream structure of FIG. 7, the style information Style Info within each Dialog such as defined in FIG. 6A and FIG. 6B may be information for linking the text subtitle of a region to one of the various style information sets defined in the DSU.

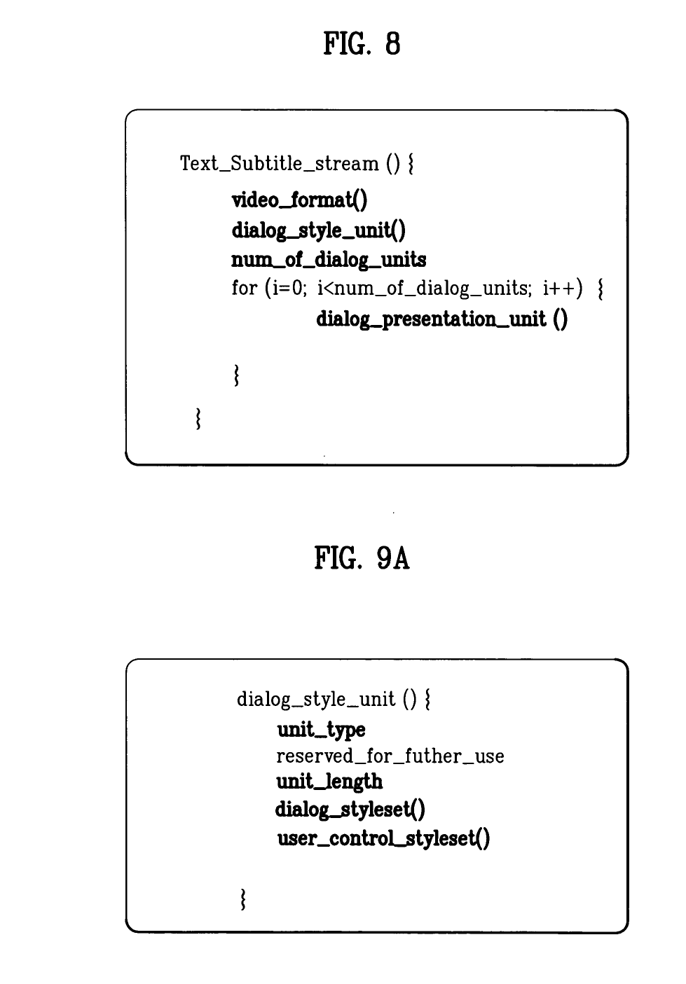

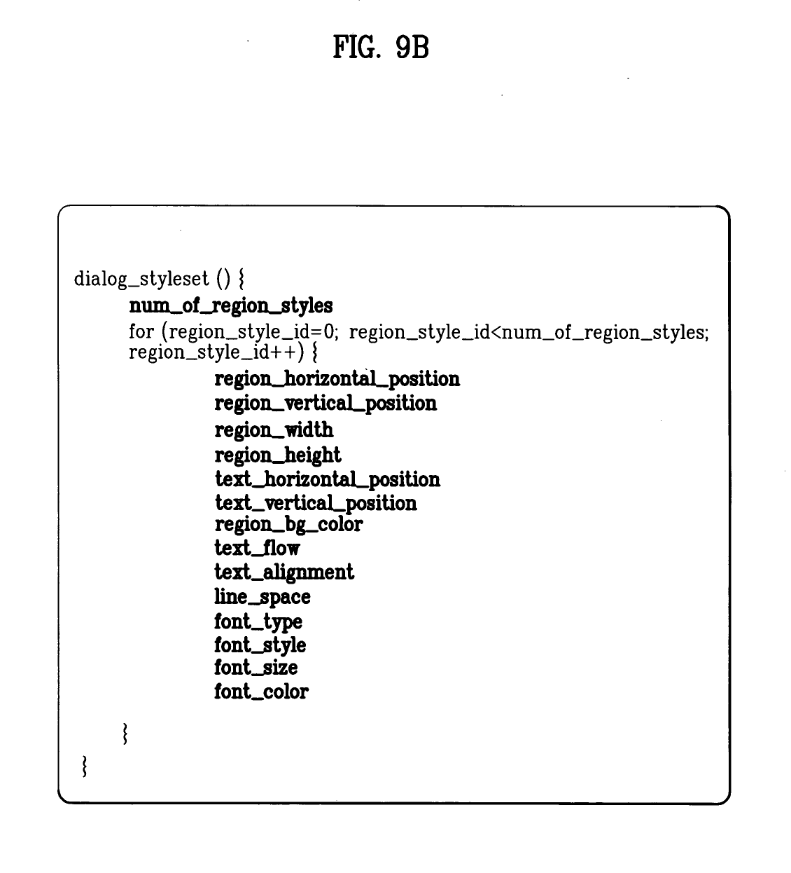

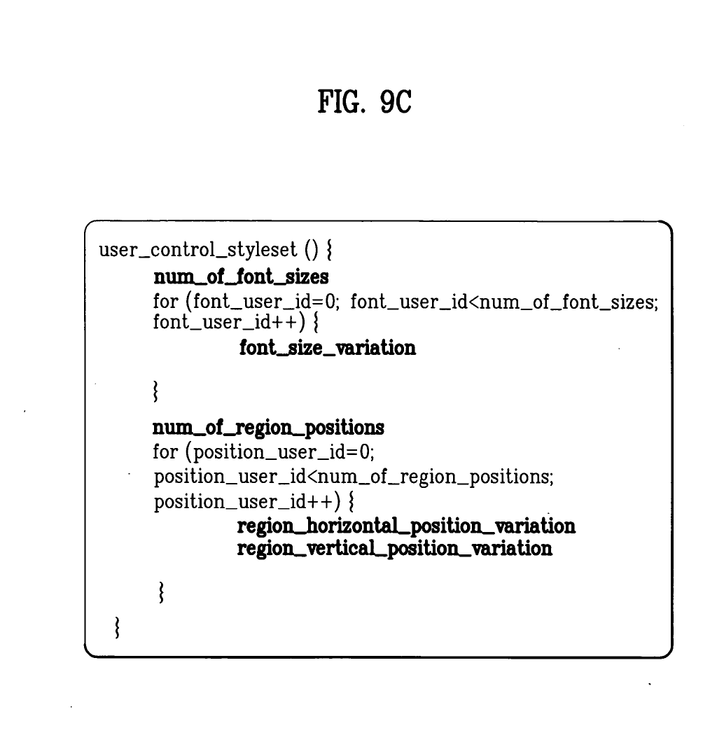

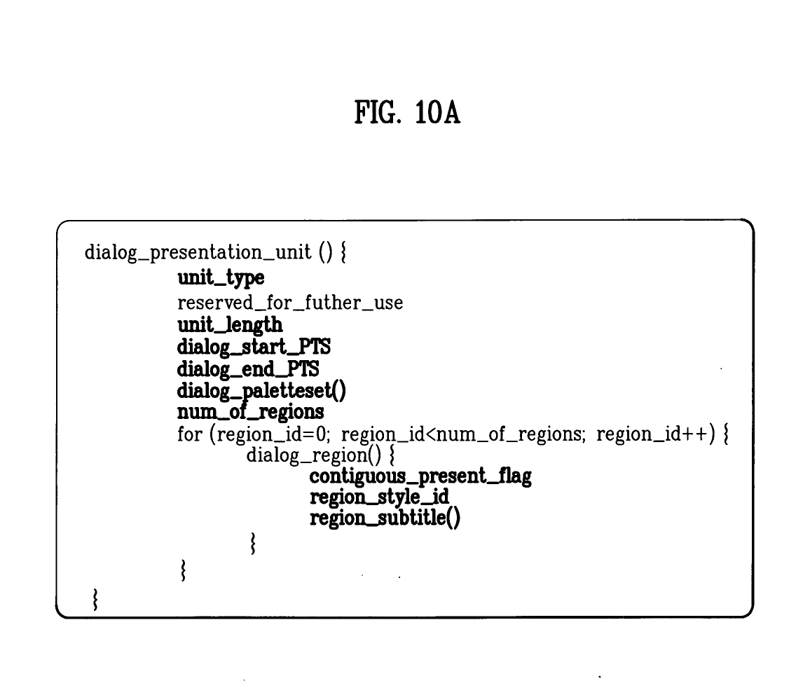

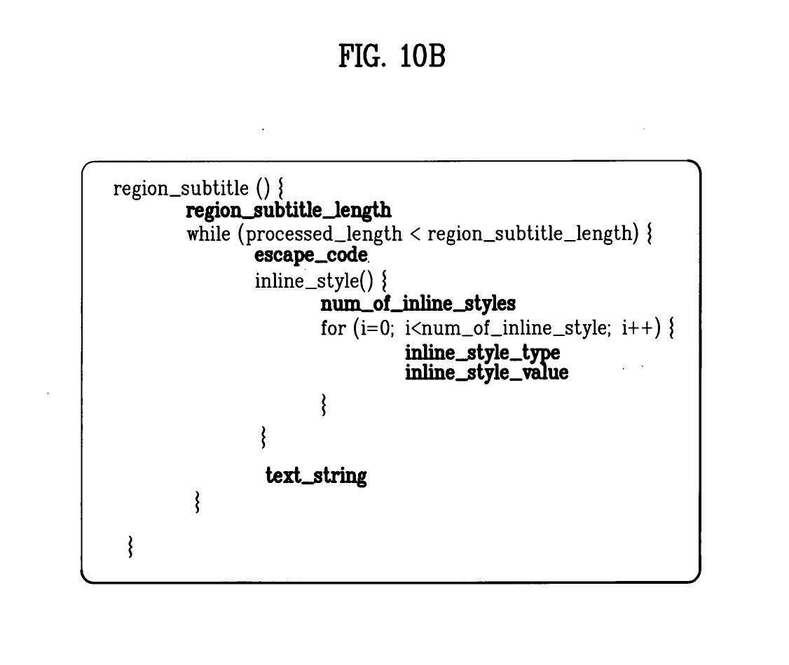

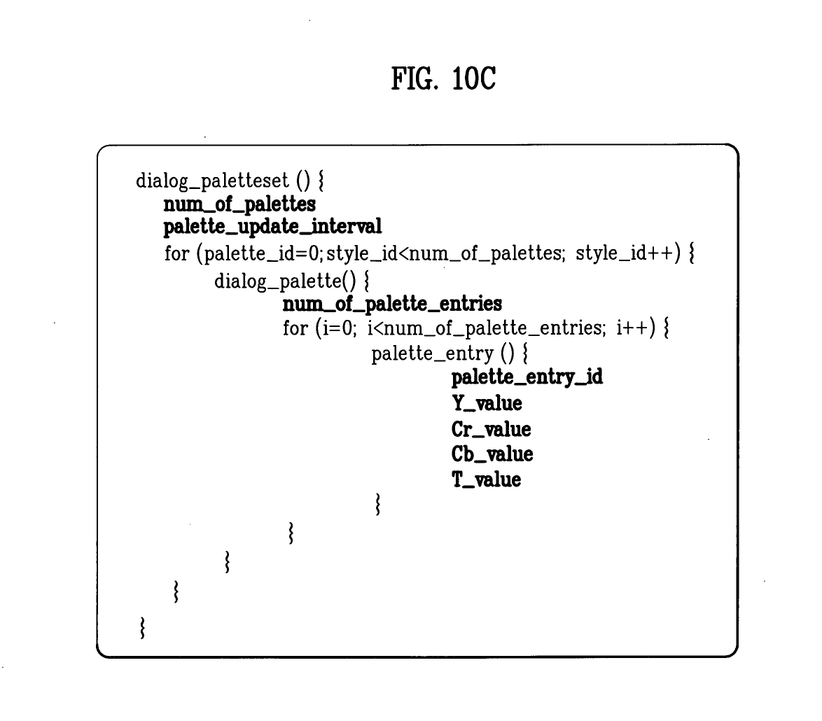

Next, the data structure syntax for a DSU and DPU according embodiments of the present invention will be explained with reference to FIGS. 8 to 10C.

FIG. 8 shows the data structure syntax of a text subtitle stream ‘Text_subtitle_stream( )’ according to one embodiment of the present invention. As mentioned in the foregoing description of FIG. 7 and shown in FIG. 8, the ‘Text_subtitle_stream( )’ data structure of the present invention includes one ‘dialog_style_unit( )’ data structure defining a style information (Style Info) set and a plurality of ‘dialog_presentation_unit( )’ data structures where real dialog information is recorded. A field ‘num_of_dialog_units’ indicates the number of ‘dialog_presentation_unit( )’ data structures in the text subtitle stream. Also, the text subtitle stream indicates the video format of the text subtitle stream in a ‘video_format( )’ data structure.

FIGS. 9A to 9C show the data structure of the ‘dialog_style_unit( )’ according to an embodiment of the present invention, and FIGS. 10A to 10C show the data structure of the ‘dialog_presentation_unit( )’ according to an embodiment of the present invention.

FIG. 9A shows an overall or high-level data structure of a ‘dialog_style_unit( )’. As shown, the ‘dialog_style_unit( )’ includes a ‘unit_type’ field that identifies this unit (or segment) as a DSU (or DSS) and a ‘unit_length’ field indicating the length of the DSU.

The DSU is divided into a ‘dialog_styleset( )’ (FIG. 9B) defining a set of various kinds of style information Style Info utilized in the Dialogs and ‘user_control_styleset( )’ (FIG. 9C) defining a set of style information Style Info that may be adjusted by a user.

FIG. 9B shows the data structure syntax for the ‘dialog_styleset( )’ according to an embodiment of the present invention. The ‘dialog_styleset( )’ provides the ‘global style information (Global Style Info)’ defined per region or alternatively called ‘region style information (Global Style Info)’ as discussed above. As shown in FIG. 9B, the ‘dialog_styleset( )’ includes a ‘num_of_region_styles’ field indicating the number of region styles provided by this ‘dialog_styleset( )’. Each region style is sequentially referenced by an identifier ‘region_style_id’ bounded by the number of region styles.

Hence, as discussed in more detail below, a Dialog will indicate the style information to apply to the Dialog by indicating the region style identifier ‘region_style_id’, and a recording/reproducing apparatus reproduces the corresponding Dialog using the style information having the same ‘region_style_id’ within the ‘dialog_styleset( )’.

For each ‘region_style_id’ the ‘dialog_styleset( )’ provides a ‘region_horizontal_position’, ‘region_vertical_position’, ‘region_width’, and ‘region_height’ fields as information defining position and size of a corresponding region within a display screen. Further provided is ‘text_horizontal_position’ and ‘text_vertical_position’ fields as information defining an origin position of text within the corresponding region. And, ‘region_bg_color_index’ information indicating a background color for the corresponding region is provided as well.

Next, defined are a ‘text_flow’ field defining text-write directions (right-to-left, left-to-right, upper-to-lower) and a ‘text_alignment’ field defining text-alignment directions (left, center, right). For the ‘text_flow’ field, in one embodiment, if a plurality of regions exist within a Dialog, each region within the corresponding Dialog is defined to have the same ‘text_flow’ value. This is to prevent a user from being confused when viewing the subtitle.

Individual style information may also be included in the style information set. For example, FIG. 9B shows the provision of ‘line_space’ information to designate an interval between lines within a region and font information for real text data such as ‘font_type’, ‘font_style’, ‘font_size’, and ‘font_color’ information.

FIG. 9C shows a data structure of the ‘user_changeable_styleset( )’ according to an embodiment of the present invention. The ‘user_changeable_styleset( )’ is the information that a user may change to make changes in the style information of text subtitle data. However, if a user is permitted to change the above-explained style information, a user's confusion may be worsened. Hence, according to this embodiment of the present invention only ‘font_size’ and ‘region_horizontal/vertical_position’ are defined as user changeable style information.

As shown, the ‘user_control_styleset( )’ syntax includes a ‘num_of_font_sizes’ field indicating the number of font sizes provided for in the ‘user_control_styleset( )’. For each font size, the ‘user_control_styleset( )’ includes ‘font_size_variation” information designating a variable range of changeable ‘font_size’. The ‘user_control_styleset( )’ also includes a ‘num_of_region_positions’ field indicating the number of regions positions provided for in the ‘user_control_styleset( )’. For each region position, the ‘user_control_styleset( )’ includes ‘region_horizontal_position_variation’ and ‘region_vertical_position_variation’ information designating a variable range of changeable ‘region_horizontal/vertical_position’.

FIG. 10A shows an overall, high-level data structure syntax of a ‘dialog_presentation_unit ( )’ according to an embodiment of the present invention. As shown, the ‘dialog_presentation_unit( )’ includes a ‘unit_type’ field that identifies this unit (or segment) as a DPU (or DPS) and a ‘unit_length’ field indicating the length of the DSU.

The DSU also includes ‘dialog_start_PTS’ and ‘dialog_end_PTS’ information designating a presentation time stamp interval of a corresponding Dialog defined within the ‘dialog_presentation_unit’.

Color change information applied to the corresponding Dialog is defined within the ‘dialog_presentation_unit ( )’ syntax by ‘dialog_paletteset( )’ syntax, which is described in greater detail below with respect to FIG. 10C.

As discussed above, in this embodiment of the present invention a Dialog may have one or two regions, which is indicated by a ‘num_of_regions’ field in the DPU. For each region a ‘dialog_region( )’ syntax defines region information within the DPU. Each region ‘dialog_region( )’ is indexed by a sequential identifier ‘region_id’, the sequence being bounded by the number of regions set forth in the a ‘num_of_regions’ field. As shown, the region information for each region includes a ‘continuous_present_flag’ field, a ‘region_style_id’ field and a ‘region_subtitle’ field.

The continuous present flag ‘continuous_present_flag’ indicates whether this DPU requires continuous playback from the previous DPU. The ‘region_style_id’ field identifies one of the region styles defined by the ‘dialog_styleset( )’ discussed above with respect to FIG. 9B. This identified region style will be applied to the subtitle data for this region during reproduction. The ‘region_subtitle( )’ syntax defines the text data and/or local style information (Local Style Info) included in this dialog region, and is described in detail below with respect to FIG. 10B.

As just mentioned, FIG. 10B shows the data structure syntax for the ‘region_subtitle( )’ data structure defined within the ‘dialog_presentation_unit( )’ syntax. As shown, the ‘region_subtitle( )’ includes a ‘region_subtitle_length’ field indicating a length of the ‘region_subtitle( )’ and an ‘escape_code” field providing an escape code. The ‘region_subtitle( )’ further includes an ‘inline_style( )’ data structure and a ‘text_string’.

The ‘text_string’ is the text data recorded within ‘region_subtitle( )’. The ‘inline_style( )’ data structure includes a ‘num_of_inline_styles’ field indicating a number of inline styles defined by this data structure. For each sequentially indexed inline style bounded by the number of inline styles, an ‘inline_style_type’ field and ‘inline_style_value’ field are provided as Local style Info applied to a specific ‘text_string’ within the ‘region_subtitle( )’.

For instance, ‘mountain’ among the text data corresponding to region #1 in FIG. 5C is described as one ‘text_string’ (‘text_string=mountain’). A font size (Font_size) of the corresponding ‘text_string=mountain’ may then be set to a value (xxx) by letting ‘inline_style_type=Font size’ and ‘inline_style_value( )=xxx’ as local style information (Local Style Info).

The ‘inline_style_type’ applicable to each ‘text_string’ may be Font Type, Font Style, Font Size, Font Color and the like. Accordingly, it will be readily apparent that various kinds of style information may be defined as necessary.

FIG. 10C shows the data structure syntax of the ‘dialog_paletteset ( )’ according to one embodiment of the present invention. The ‘dialog_paletteset ( )’ syntax provides color change information for text subtitle data written within the Dialog. As shown, the ‘dialog_paletteset ( )’ includes a ‘num_of_palettes’ field indicating the number of palettes defined in this ‘dialog_paletteset ( )’, and a ‘pallette_update_interval’ field designating a Fade-in/out effect of text data.

For each number of palettes, the ‘dialog_paletteset ( )’ includes a ‘dialog palettes( )’ data structure indexed by a sequential palette_id bounded by the number of palettes. Each ‘dialog palette( )’ data structure includes a ‘num_of_palette_entries’ field indicating the number of ‘palette entries( )’ in the dialog palette. For each ‘palette entry( )’ the ‘dialog palette( )’ provides a ‘palette_hentry_id’ field, a ‘Y_value’ field, a ‘Cr_value’ field, a ‘Cb_value’ field and a ‘T_value’ field. The ‘palette_entry_id’ field provides an identifier for this ‘palette_entry( )’. The ‘Y_value’ field provides a luminance value while the ‘Cr_value’ and the ‘Cb_value” fields provide chrominance values to create a brightness and color for the text data. The ‘T_value’ is information provided to indicate transparency of the text data.

Hence, in the text subtitle data, color may be defined by Global Style Info or Local Style Info and the information for the variation and/or transparency of the color may be provided by the ‘dialog_paletteset( )’ syntax.

FIG. 11 is a block diagram of an optical recording/reproducing apparatus for reproducing text subtitle stream according to the present invention. As shown, the apparatus includes a pickup unit 11 reading out main data, a text subtitle stream, and associated reproducing/management information recorded in an optical disc; a servo 14 controlling operation of the pickup unit 11; a signal processing unit 13 restoring a reproducing signal received from the pickup unit 11 into a wanted signal value or modulating an input signal into a signal to be recorded in the optical disc; a memory 15 storing information required for system operation (e.g., reproduced management information such as discussed above with respect to FIGS. 1-10C); and a microcomputer 16 controlling the operation of the servo 14, the signal processor unit 13 and the memory 15.

As further shown, an AV and text subtitle (ST) decoder 17 decodes data output from the signal processor unit 13 after being buffered by a buffer 19. The buffer 19 buffers (i.e., stores) the text subtitle stream in order to decode the text subtitle data.

In order to perform a function of recording a signal in the optical disc, an AV encoder 18 converts an input signal to a specifically formatted signal such as MPEG2 transport stream, under the control of the control unit 12, and provides the converted signal to the signal processing unit 13.

The control unit 12 controls the overall operation of the optical recording/reproducing apparatus. Once a specific-language text subtitle playback request command is inputted via a user interface operatively connected to the control unit 12, the control unit 12 controls the apparatus to preload the corresponding text subtitle stream into the buffer 19. The control unit 12 then controls the decoder 17 by referring to the above-explained dialog information, region information, style information (Style Info), and the like among the text subtitle stream information stored in the buffer 19 so that real text data is displayed at a specific position on a screen with a specific size. For recording, the control unit 12 controls, via instructions received from the user interface, the AV encoder 18 to encode AV input data. The control unit 12 also controls the signal processor unit 13 to process the encoded data and command data from the control unit 12 to record data structures on the recording medium such as discussed above with respect to FIGS. 1-10C.

While the invention has been disclosed with respect to a limited number of embodiments, those skilled in the art, having the benefit of this disclosure, will appreciate numerous modifications and variations there from. For example, while described with respect to a Blu-ray ROM optical disk in several instances, the present invention is not limited to this standard of optical disk or to optical disks. It is intended that all such modifications and variations fall within the spirit and scope of the invention.

1. A recording medium having a data structure for managing reproduction of text subtitles, comprising:
a recording area storing a dialog presentation segment including text subtitle data of each text subtitle for presentation during a presentation time slot, the dialog presentation segment providing a presentation time stamp start time and a presentation time stamp end time defining the presentation time slot such that the presentation time slot does not overlap a presentation time slot of another dialog presentation segment.

2. The recording medium of claim 1, wherein the dialog presentation segment defines a number of regions, each region providing text subtitle data.

3. The recording medium of claim 2, wherein the text subtitle data is one of text string data and style data.

4. The recording medium of claim 2, wherein the dialog presentation segment defines two regions at most.

5. The recording medium of claim 2, wherein the dialog presentation segment references a region style for each region, the referenced region style defines a position and size of the region.

6. The recording medium of claim 5, wherein
the recording area stores a dialog style segment associated with the dialog presentation segment, and the dialog style segment defines one or more region styles.

7. The recording medium of claim 6, wherein
the recording area stores a text subtitle stream including the dialog style segment and the dialog presentation segment.

8. The recording medium of claim 2, wherein the dialog presentation segment include continuous presentation information for each region indicating whether the region is to be continuously reproduced from a previous dialog presentation segment.

9. The recording medium of claim 8, wherein the continuous presentation information for each region is a flag.

10. The recording medium of claim 8, wherein the presentation time stamp start time of the dialog presentation segment equals a dialog presentation time stamp end time of the previous dialog presentation segment when the continuous presentation information of a region in the dialog presentation segment indicates continuous reproduction.

11. The recording medium of claim 10, wherein the dialog presentation segment references a region style for each region, the referenced region style defines a position and size of the region, and when a region of the dialog presentation segment includes the continuous presentation information indicating continuous presentation, the referenced region style for the region is a same region style referenced by a region in the previous dialog presentation segment.

12. The recording medium of claim 1, wherein the dialog presentation segment include continuous presentation information indicating whether the dialog presentation segment is to be continuously reproduced from a previous dialog presentation segment.

13. The recording medium of claim 12, wherein the continuous presentation information for each region is a flag.

14. The recording medium of claim 12, wherein the presentation time stamp start time of the dialog presentation segment equals a dialog presentation time stamp end time of the previous dialog presentation segment when the continuous presentation information in the dialog presentation segment indicates continuous reproduction.

15. The recording medium of claim 14, wherein the dialog presentation segment and the previous dialog presentation segment reference same style information when the when the continuous presentation information in the dialog presentation segment indicates continuous reproduction.

16. The recording medium of claim 1, wherein the recording area stores the dialog presentation segment as a single packet elementary stream.

17. The recording medium of claim 1, wherein the dialog presentation segment includes a type indicator indicating that the dialog presentation segment is a dialog presentation segment.

18. A recording medium having a data structure for managing text subtitles, comprising:
a recording area storing a text subtitle stream, the text subtitle stream includes a dialog style segment followed by one or more dialog presentation segments, the dialog style segment defining one or more styles, each dialog presentation segment including text subtitle data of each text subtitle for presentation during a presentation time slot, each dialog presentation segment references at least one of the styles in the dialog style segment, and each dialog presentation segment providing a presentation time stamp start time and a presentation time stamp end time defining the presentation time slot such that the presentation time slot does not overlap a presentation time slot of another dialog presentation segment.

19. The recording medium of claim 18, wherein each dialog presentation segment defines a number of regions, each region providing text subtitle data, and the dialog presentation segment references a style from the dialog style segment for each region, the referenced style defining a position and size of the region.

20. The recording medium of claim 18, wherein each dialog presentation segment defines a number of regions, each region providing text subtitle data, and each dialog presentation segment includes continuous presentation information for each region indicating whether the region is to be continuously reproduced from a previous dialog presentation segment.

21. The recording medium of claim 20, wherein each dialog presentation segment provides a presentation time stamp start time and a presentation time stamp end time defining the presentation time slot, and the presentation time stamp start time of a current dialog presentation segment equals a dialog presentation time stamp end time of the previous dialog presentation segment when the continuous presentation information of a region in the current dialog presentation segment indicates continuous reproduction.

22. The recording medium of claim 21, wherein each dialog presentation segment references a style from the dialog style segment for each region, the referenced style defines a position and size of the region, and when a region of the current dialog presentation segment includes the continuous presentation information indicating continuous presentation, the referenced style for the region is a same style referenced by a region in the previous dialog presentation segment.

23. The recording medium of claim 18, wherein the recording area stores the dialog style segment and each dialog presentation segment as a single packet elementary stream.

24. A method of reproducing a data structure for managing text subtitles from a recording medium, comprising:
reproducing a dialog presentation segment from the recording medium, the dialog presentation segment including text subtitle data of each text subtitle for presentation during a presentation time slot, the dialog presentation segment providing a presentation time stamp start time and a presentation time stamp end time defining the presentation time slot such that the presentation time slot does not overlap a presentation time slot of another dialog presentation segment.

25. A method of recording a data structure for managing text subtitles on a recording medium, comprising:
recording a dialog presentation segment on the recording medium, the dialog presentation segment including text subtitle data of each text subtitle for presentation during a presentation time slot, the dialog presentation segment providing a presentation time stamp start time and a presentation time stamp end time defining the presentation time slot such that the presentation time slot does not overlap a presentation time slot of another dialog presentation segment.

26. An apparatus for reproducing a data structure for managing text subtitles from a recording medium, comprising:
a driver for driving an optical reproducing device to reproduce data recorded on the recording medium; and
a controller for controlling the driver to reproduce a dialog presentation segment from the recording medium, the dialog presentation segment including text subtitle data of each text subtitle for presentation during a presentation time slot, the dialog presentation segment providing a presentation time stamp start time and a presentation time stamp end time defining the presentation time slot such that the presentation time slot does not overlap a presentation time slot of another dialog presentation segment.

27. An apparatus for recording a data structure for managing text subtitles on a recording medium, comprising:
a driver for driving an optical recording device to record data on the recording medium;
a controller for controlling the driver to record a dialog presentation segment on the recording medium, the dialog presentation segment including text subtitle data of each text subtitle for presentation during a presentation time slot, the dialog presentation segment providing a presentation time stamp start time and a presentation time stamp end time defining the presentation time slot such that the presentation time slot does not overlap a presentation time slot of another dialog presentation segment.
